(19) United States
(12) Patent Application Publication
(10) Pub. No.: US 2006/0027104 A1
(43) Pub. Date: Feb. 9, 2006

(54) Flexible baking apparatus

(76) Inventor: Charles B. Perez JR., Venice, CA (US)

Correspondence Address: SYLMARK, INC., 4929 WILSHIRE BLVD, SUITE 500, LOS ANGELES, CA, 90010, US

(21) Appl. No.: 11/198,051

(22) Filed: Aug. 4, 2005

Related U.S. Application Data
(60) Provisional application No. 60/599,526, filed on Aug. 5, 2004.

(51) Int. Cl. A47J 43/18

(52) U.S. Cl. 99/426

(57) ABSTRACT

A flexible baking apparatus is disclosed having a strip of malleable material configured to be hand-manipulated into a desired shape. The malleable strip material is a thermoplastic, metal, alloy or other material capable of withstanding high temperatures. After forming the desired shape, the ends of the strip are joined together to form a baking vessel.

### RELATED APPLICATIONS

The present application is related to U.S. Provisional App. No. 60/599,526 filed on Aug. 6, 2004.

### FIELD OF INVENTION

The present invention relates generally to baking containers, and more particularly, to flexible baking apparatus which can be manually manipulated to alter the design of the resultant baked goods.

### BACKGROUND OF THE INVENTION

Cakes are typically made in cake pans having fixed dimensions. Specifically, cake batter is poured into a pan, and thereafter baked until the batter solidifies. The resultant cake will have the shape of the pan used during the cooking process. The typical cake pans have geometric shapes, like a circle, square or rectangle. Fancier cake pans have more elaborate shapes, like, animals, flowers or other characters.

There are instances when the baker desires to bake a cake of a specific shape. For instance, the baker may want a cake shaped like a cat or other animal. One way to get a cat-shaped cake is to purchase a specially designed cake pan which is pre-formed into a cat configuration. If the baker then wishes to bake a cake shaped like a flower, another pre-formed cake pan will be needed. The baker will be required to accumulate pre-formed pans, which could be costly. Furthermore, the pans, which are typically bulky, will require storage space in the kitchen. As a result, it is impractical for the average baker to bake cakes in a variety of shapes and patterns.

Another disadvantage of the pre-formed pans is that the baker is limited to the shapes that are commercially available. If the baker desires an unusual design, it would be difficult, if not impossible, to find the pre-formed pan. As a practical matter, therefore, the bakers are limited to the pan shapes that are commonly used by the public.

Another method of creating cakes of specific shapes is to bake a round or rectangular cake and then carve out portions of the cake to create the desired shape. This method is difficult and requires some artistic aptitude to achieve the desired result. Furthermore, even if one has the ability to create the design, much of the cake is carved out and discarded, and therefore wasted. Another drawback is that, where the cake has been carved, the edges of the cake are no longer smooth and finished, resulting in a more difficult surface to decorate.

Accordingly, there is a continuing need for a baking apparatus which is particularly suited for baking cakes and the like and can be manually manipulated in shape to create any desired profile.

### SUMMARY OF PREFERRED EMBODIMENTS

A flexible baking apparatus is disclosed. In a preferred embodiment of the invention, the flexible baking apparatus is a strip of malleable material configured to be hand-manipulated into a desired shape. The malleable strip material is a thermoplastic, metal, alloy or other material capable of withstanding high temperatures. After forming the desired shape, the ends of the strip are joined together to form a baking vessel.

In one embodiment of the invention, the flexible baking apparatus is made of link members pivotally attached to each other.

The flexible baking apparatus can be partially or entirely covered by a top layer. In a preferred embodiment of the invention, the top layer comprises aluminum foil or a silicone-based material.

### BRIEF DESCRIPTION OF DRAWINGS

FIG. 1 is a perspective view of a preferred embodiment of a flexible baking apparatus of the present invention;

FIG. 2 is a perspective view of individual links of the apparatus shown in FIG. 1;

FIG. 3 is a partial cut-away view of another preferred embodiment the flexible baking apparatus of the present invention;

FIG. 4 is a partial cut-away view of yet another preferred embodiment the flexible baking apparatus of the present invention;

FIG. 5 is a perspective view of a preferred embodiment of the flexible baking apparatus of the present invention as formed into a predetermined shape and filled with batter;

FIG. 6 is a perspective view of a resultant cake baked in the flexible baking apparatus of the present invention; and

FIG. 7 is a perspective view of another cake configuration made using the flexible baking apparatus of the present invention.

### DETAILED DESCRIPTION OF PREFERRED EMBODIMENTS

As shown in the accompanying drawings for purpose of illustration, the present invention resides in a baking apparatus, generally referred to by the reference number 10, which is configured and designed such that the user thereof can manually manipulate the apparatus 10 into a plurality of different shapes so as to create baked goods having different profiles.

The term “batter” is used herein to refer to any liquid or semi-liquid mixture that can be transformed into a solid or semi-solid state. The word “cake” is used herein to refer to the solid or semi-solid state of the batter, and should not be limited to a mixture of any specified ingredients.

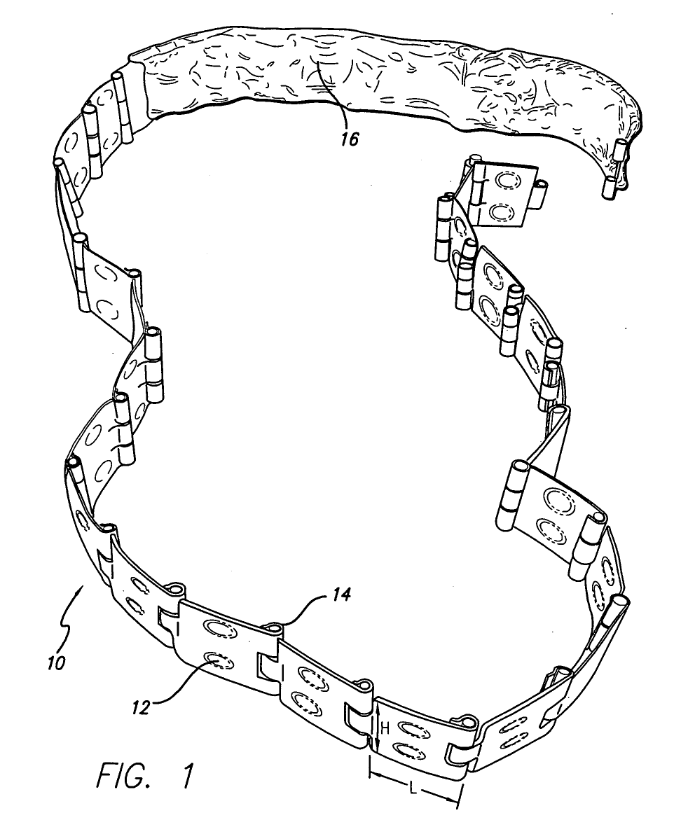

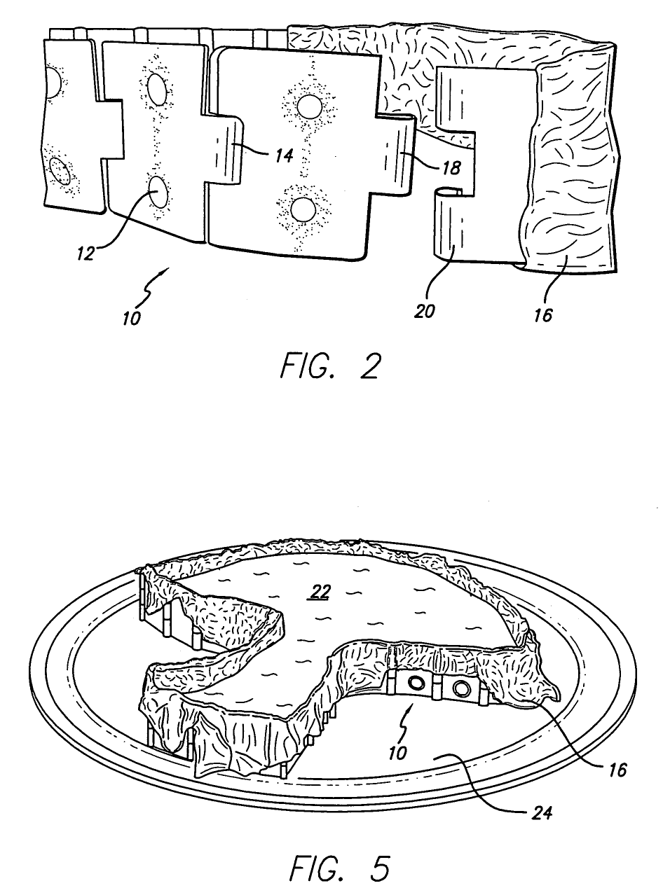

With reference now to FIGS. 1 and 2, a particularly preferred embodiment of the invention is illustrated. Generally speaking, the apparatus 10 has a predetermined height H, a link length L, and a total length. In a preferred embodiment of the invention, the height H of the apparatus is preferably about 1½ inches, and the link length is about 1¼ to 1½ inches. The total length of the apparatus 10 is preferably between 3 and 4 feet. The height and length can be modified to suit the needs of the user.

The apparatus is configured and designed so that it can be moved into various shapes. As illustrated in FIGS. 1 and 2, the apparatus 10 is comprised of a plurality of link members 12 which are pivotally joined together. The link members 12 can be pivotally connected in many ways known to those skilled in the art. In a preferred embodiment of the invention, as shown in FIGS. 1 and 2, the link members 12 are joined via hinges 14. The hinges 14 shown in FIGS. 1 and 2 are piano hinges. However, it is envisioned that those skilled in the art can utilize other types of hinges without departing from the present invention.

The link members 12 and hinges 14 are preferably comprised of material which can withstand baking temperatures, namely, temperatures up to 400-500 degrees Fahrenheit. More preferably, the link members 12 and hinges 14 comprise a material that is dishwasher safe and not susceptible to rust or other types of corrosion.

As shown in FIGS. 1 and 2, the link members 12 are hinged to one another to create one continuous length of metal links. Each link member 12 is preferably fairly small in length so that the apparatus 10 can be manipulated into many shapes without substantial restriction. However, as discussed above, the height and length of the link members 12, and the total number of members used in the apparatus 10 can be modified as desired. In a preferred embodiment of the invention, numerous apparatuses 10 are provided as a set, thereby allowing the user to interconnect two or more of the apparatuses 10 to achieve the desired circumference for the cake. This would enable the user to adjust the size of the apparatus 10 depending on the size of the cake desired to be baked.

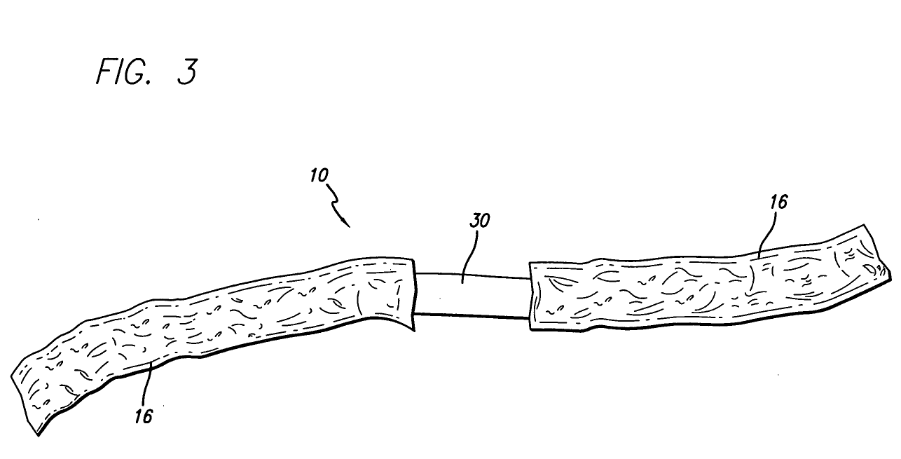

In another preferred embodiment of the invention, shown in FIG. 3, apparatus 10 is not constructed of link members. Rather, apparatus 10 comprises a strip 30 of malleable material that is continuous in form. As with the pivotable link members, the strip of malleable material can be manipulated to form curves, lines and other desired configurations. The malleable material is preferably of a type that can easily yield to pressure applied by the user, yet sufficiently rigid to maintain its form when the batter is poured therein. Furthermore, the malleable material must withstand baking temperatures. In a preferred embodiment of the invention, the malleable material is a thermoplastic, metal or metal alloy material. It is envisioned that numerous other materials known to those skilled in the art can be utilized.

In a preferred embodiment of the invention, as shown in FIGS. 1 through 4, the apparatus 10 is covered by a top layer 16. The top layer 16 keeps the batter from coming into direct contact with the apparatus 10, keeping the surface of the apparatus clean, and thereby reducing the likelihood of corrosion. In the embodiment wherein hinges 14 are used, the top layer 16 prevents batter from seeping into the hinge mechanism. In a preferred embodiment of the invention, the top layer 16 comprises aluminum foil or other similar type of disposable covering. Aluminum foil is wrapped around the inside and bottom surfaces of the apparatus 10 to partially or completely cover the apparatus 10. After the baking process, the aluminum foil cover can be removed and discarded.

In another preferred embodiment of the invention, the top layer 16 is not disposable. For example, in one embodiment, a silicone-based cover can be affixed to the apparatus 10. Those skilled in the art are familiar with various types of silicone-based material that are used in cooking and baking appliances. The advantage of using a silicone-based cover is that the material withstands high temperatures, conducts heat evenly and can be washed with ordinary detergents. Those skilled in the art will know that other material can be used as the top layer without departing from the invention.

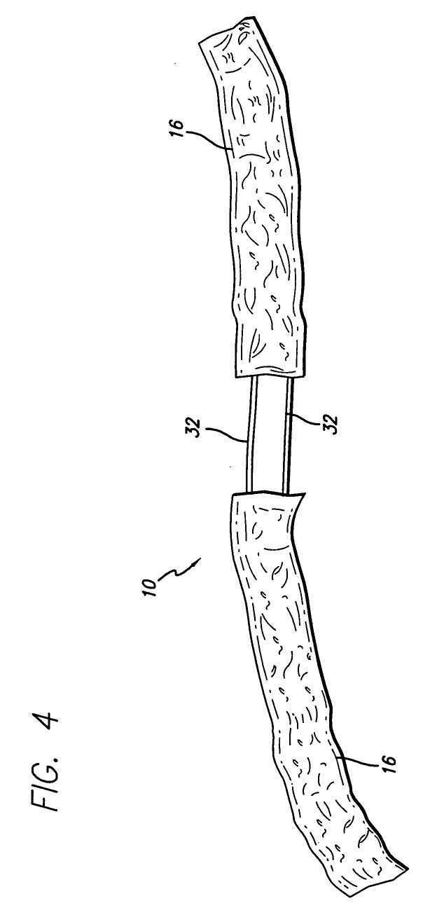

FIG. 4 depicts another embodiment of the invention wherein the apparatus 10 includes one or more strips of malleable material 32 embedded in or supporting the top layer 16. As with strip 30, shown in FIG. 3, the strips 32 can be manipulated to form curves, lines and other desired configurations. The malleable material is preferably of a type that can easily yield to pressure applied by the user, yet sufficiently rigid to maintain its form when the batter is poured therein. Furthermore, the malleable material must withstand baking temperatures. In a preferred embodiment of the invention, the malleable material is a thermoplastic, metal or metal alloy material and the cover 16 is silicone-based.

To use the flexible baking apparatus, the apparatus 10 is hand-manipulated into the desired shape. For example, the apparatus 10 can be formed into the shape of a mushroom (shown in FIG. 5) or a cat (shown in FIG. 7). The ends 18 and 20 of the apparatus 10 are then brought together in mating fashion. In the embodiment wherein hinges 14 are used, the ends 18 and 20 are brought together such that the apertures thereof are aligned. This allows a pin, toothpick or the like to be inserted through the aligned apertures of the ends 18 and 20 to secure them in place. In other preferred embodiments of the invention, a latch or other mating mechanisms can be used to close the loop.

With reference now to FIG. 5, once the apparatus 10 is manipulated into the desired shape, it is placed on a baking pan 24 such as a cookie sheet or a pizza pan. The baking pan 24 constitutes the bottom surface support for the cake. The batter 22 is then poured directly into the flexible baking apparatus 10. The batter 22, although liquid, is retained within the apparatus 10 due to contact between the apparatus bottom surface 10 and the pan 24. In one embodiment of the invention, a gasket (not shown) is used to seal any gaps between the flexible baking apparatus 10 and the baking pan 24. Furthermore, wrapping the top layer 16 substantially around the link members 12 of the apparatus 10 also assists in keeping the liquid batter 22 in place.

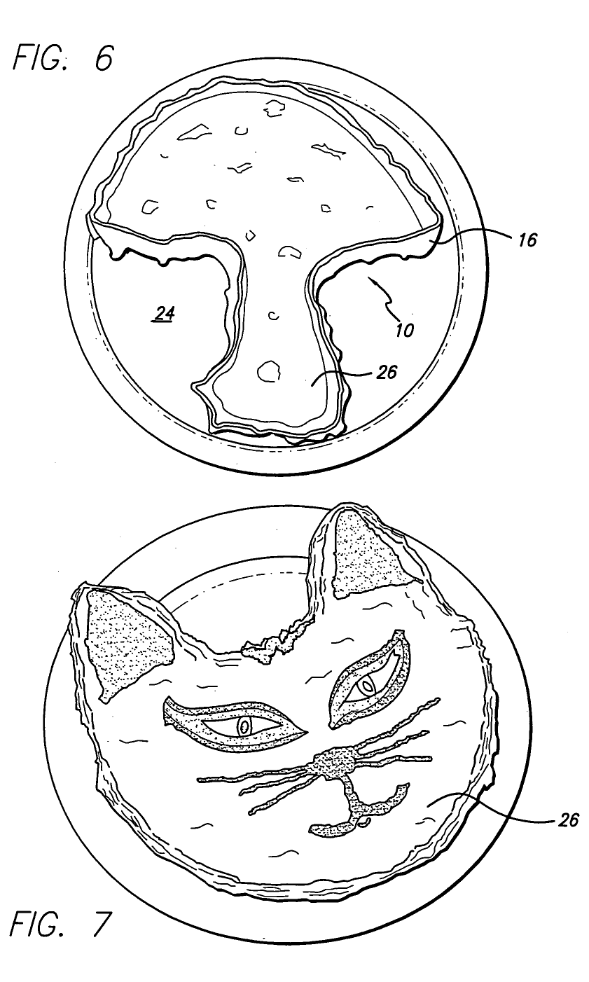

After the batter 22 is poured into the flexible baking apparatus, the baking pan 24 and the flexible baking apparatus 10, are inserted into the oven as illustrated in FIG. 5, and the cake is baked in a traditional fashion. The result, as illustrated in FIG. 6, is a baked cake 26 having a shape and profile reflecting that of the previously manipulated apparatus 10, in this case, a mushroom profile.

With reference now to FIG. 7, another cake 26 is illustrated having a “cat” profile created using the apparatus 10 of the present invention. It will be appreciated that the resultant cake profiles are not limited to those shown in the figures but can have numerous configurations, limited only by the imagination of the baker. The baking apparatus 10 of the present invention enables the baking of different cake profiles without purchasing multiple specialty cake pans. There is no need to store multiple cake pans. Furthermore, because the resultant cake is in the desired shape, there is no need to carve out portions of the cake. No food is wasted and the cake has a “finished” outer edge, making it is easier to decorate than a cut edge.

Although the apparatus 10 is described in the context of baking, it is envisioned that the apparatus can be used as a mold to solidify any liquid or semi-liquid mixture, including, but not limited to the making of gelatin, flan, ice, or iced desserts.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A flexible baking apparatus, comprising:
a plurality of link members, each link member pivotally attached to an adjacent link member, wherein the link members can be manipulated to create a desired shape;
a first end and a second end, wherein the first and second ends are joined together to form a closed baking vessel; and
wherein the link members comprise a heat resistant material.

2. The flexible baking apparatus of claim 1 wherein each link member is hingedly attached to the adjacent link member.

3. The flexible baking apparatus of claim 1 further comprising a top layer at least partially covering the plurality of link members.

4. The flexible baking apparatus of claim 3 wherein the top layer comprises aluminum foil.

5. The flexible baking apparatus of claim 3 wherein the top layer comprises a silicone-based material.

6. The flexible baking apparatus of claim 3 wherein the top layer is disposable.

7. The flexible baking apparatus of claim 3 wherein the top layer is affixed to at least one of the plurality of link members.

8. A flexible baking apparatus, comprising a strip of malleable material, the strip having a first end and a second end, wherein said strip is configured to be hand-manipulated into a desired shape, wherein the malleable material is configured to withstand baking temperatures, and wherein the first end and the second end are joined together to form a baking vessel.

9. The flexible baking apparatus of claim 7, further comprising a plurality of link members, each link member pivotally attached to an adjacent link member.

10. The flexible baking apparatus of claim 9 wherein each link member is hingedly attached to the adjacent link member.

11. The flexible baking apparatus of claim 7 further comprising a top layer at least partially covering the strip.

12. The flexible baking apparatus of claim 11 wherein the top layer comprises aluminum foil.

13. The flexible baking apparatus of claim 11 wherein the top layer comprises a silicone-based material.

14. The flexible baking apparatus of claim 13 wherein the strip comprises a first strip and a second strip, and wherein the first and second strips are embedded in top layer.

15. A method of baking a cake, comprising the steps of:
providing a strip of malleable material having a first end and a second end;
manipulating the strip to a desired shape;
joining the first end and second end of the strip together to form a baking vessel having a selected shape;
placing the baking vessel on a baking pan;
pouring batter into the baking vessel; and
obtaining a resultant cake in the selected shape of the baking vessel.

16. The method of claim 15 further comprising the steps of providing a gasket between the baking vessel and the baking pan.

17. The method of claim 15 further comprising the steps of providing a top layer on the strip.

18. The method of claim 17 wherein the top layer comprises a silicone-based material.

19. The method of claim 15 wherein the strip comprises a plurality of link members pivotally connected to each other.
